(19) United States
(12) Patent Application Publication
(10) Pub. No.: US 2025/0258083 A1
(43) Pub. Date: Aug. 14, 2025

(54) METHOD FOR DETERMINING A PARTICLE DISTRIBUTION

(71) Applicants: TRUMPF PHOTONIC COMPONENTS GMBH, Ulm (DE); ROBERT BOSCH GMBH, Stuttgart (DE)

(72) Inventors: Hans Spruit, Waalre (NL); Okke Ouweltjes, Eindhoven (NL); Alexander Marc Van Der Lee, Venlo (NL); Robert Weiss, Waldbronn (DE)

(21) Appl. No.: 18/844,695

(22) PCT Filed: Mar. 8, 2023
(86) PCT No.: PCT/EP2023/055869

§ 371 Date: Sep. 6, 2024

(30) Foreign Application Priority Data
Mar. 9, 2022 (DE) 10 2022 105 560.4

(51) Int. Cl. G01N 15/1434; G01N 15/14

(52) U.S. Cl. CPC G01N 15/1434; G01N 2015/1493

(57) ABSTRACT

A method for determining a particle distribution in a particle stream (10) using a laser apparatus (12) which has a semiconductor laser (14) that emits a laser light (16) having an inhomogeneous intensity profile (30), characterised by
receiving a light reflection (20) of the laser light (16) generated at particles (18) of the particle stream (10),
an evaluation unit (22) connected to the laser apparatus (12) evaluating a reflection signal generated by the light reflection (20) in respect of a frequency distribution of signal strength values which is generated on the basis of the intensity profile (30) when the particles (18) penetrate the laser light (16),
a processor unit determining the particle diameters of the individual particles on the basis of the signal strength values,
carrying out a diameter correction of at least some of the determined particle diameters on the basis of the sensitivity of the laser apparatus,
creating a diameter list of the frequency distribution of the particle diameters,
carrying out a frequency correction of the diameter list using a correction list,
storing the corrected diameter list on a storage medium.

The present invention relates to a method for determining a particle distribution in a particle stream using a laser apparatus which has a semiconductor laser. The invention also relates to a computer program product which includes the steps of such a method and to a laser apparatus for carrying out the method.

### PRIOR ART

The background to the invention is the detection of PM1, PM2.5 and PM10 values, the detection being based on the particle mass in μg/m³ for particle sizes below 1, 2.5 or 10micrometres.

WO 2017017282 A1 discloses a method for deriving particle sizes from measured signals. A laser sensor module for particle size detection is described. The laser sensor module comprises at least one first laser, at least one first detector, at least one electrical driver and at least one evaluation device. The first laser is adapted to emit first laser light in response to signals provided by the at least one driver.

For an accurate determination of the PM1, PM2.5 and PM10 values, a good estimate of the particle size detected is needed. Although larger particles generally lead to longer detection times and/or larger detection amplitudes, large particles often also generate very weak signals. This is the case if a particle passes through an edge region of the laser beam transmitted for the detection. However, if a particle penetrates the focus of the laser beam, it can generate a reflection that has a high light intensity. A strong signal is detected as a result. Here, strong and weak signals are to be understood in the sense of a signal-to-noise ratio, in which the power of a useful signal is in relation to noise.

The problem solved by the present invention consists in providing a method, which enables a more accurate determination of a particle distribution in a particle stream.

### DISCLOSURE OF THE INVENTION

It is proposed to provide a method for determining a particle distribution in a particle stream using a laser apparatus, wherein the laser apparatus has a semiconductor laser which emits a laser light having an inhomogeneous intensity profile extending preferably transversely to the propagation direction and/or in the propagation direction of the laser light, the following steps being carried out in the method: receiving a light reflection of the laser light generated at particles of the particle stream; an evaluation unit connected to the laser apparatus evaluating a reflection signal generated by the light reflection in respect of a frequency distribution of signal strength values which is generated on the basis of the intensity profile when the particles penetrate the laser light; a processor unit determining the particle diameter of the individual particles on the basis of the signal strength values; a diameter correction of at least some of the determined particle diameters on the basis of the sensitivity of the laser apparatus; creating a diameter list of the frequency distribution of the particle diameters; a frequency correction of the diameter list using a correction list; and storing the corrected diameter list on a storage medium.

This makes it possible to determine a particle distribution which enables a more accurate statement to be made about the number and the size of the particles in the particle stream.

The diameter correction provides a diameter-dependent correction of the determined particle diameters. This is therefore particularly advantageous as the backscatter of the laser light depends on the wavelength of the laser light and the particle diameters. Because the wavelength is constant or only varies within a narrow band in the preferably infrared range and has no influence on the particle diameters under real conditions, the dependence on the wavelength of the laser light and the particle diameters must be taken into account by the diameter correction.

In the diameter list, different classes of particle diameters are listed in histogram form, in which the occurrence frequency of each of the particle diameters in the particle stream preferably during a measurement duration is listed.

The frequency correction makes it possible to approximate the frequency distribution actually present in the particle stream. For this purpose, in particular frequency values of particle diameters that are created in the correction list can be subtracted from the frequency distribution.

The detection can be effected by the semiconductor laser component itself and/or by an additional photodiode.

Advantageous designs and refinements of the invention are possible owing to the measures mentioned in the dependent claims.

Advantageously, the particle diameter is determined on the basis of a measurement duration and a flow velocity of the particles. In this case, the particle diameter can be determined according to

d˜SNR^{0.5}t^{1.5} v²

where v is the flow velocity, t is the measurement duration, SRN is the signal strength value and d is the particle diameter. Here, the flow velocity can be determined by GPS data, by data from a weather service and/or data from a measurement with the laser apparatus and/or an additional sensor apparatus. As an alternative or in addition, a periodic frequency modulation can be applied to the laser light, so that a speed of the particles which pass through the laser light can be determined.

A particular refinement involves the diameter correction being effected for particle diameters <1 micrometre. Here, the determined particle diameter d is reduced in size according to

d′=d0.5

if the particle diameter is <1 micrometre. If the particle diameter is <0.1 micrometre, a greater diameter correction is carried out, which is

d″=d^{0.25}

According to the method, the correction list is created by storing the frequency distribution of the particle diameters that are smaller than a representative particle diameter from the diameter list. Here, the correction list is created from the particle diameters that do not correspond to the representative particle diameter.

In a preferred exemplary embodiment, the frequency of particle diameters that are smaller than the representative particle diameter can be reduced by the frequency correction using the correction list. As a result, the frequency of the representative particle diameter is not reduced, so that it can be assumed that the actual frequency of a particle diameter in the particle stream that corresponds to the representative particle diameter is not lower than the frequency of the uncorrected representative particle diameter.

In order to come as close as possible to the actual frequency of the representative particle diameter in the particle stream, the frequency of the representative particle diameter is increased by the correction list. In this case, the frequency of the representative particle diameter is increased by the number of particles that have a smaller particle diameter than the representative particle diameter.

The number of different diameters in the diameter list specifies the repetitions of the frequency corrections to the diameter list, wherein the largest particle diameter in the diameter list is selected as representative particle diameter in the first frequency correction and the smallest particle diameter in the diameter list is selected as the representative diameter in the last frequency correction. With each of the correction iteration steps, the frequency of the particle diameter selected as representative particle diameter is corrected.

In order to obtain the simplest correction algorithm possible, the correction list can be determined only once for a representative diameter that corresponds to the largest diameter in the diameter list, with this correction list being used for all frequency corrections. The correction list can be determined in the factory for a typical particle distribution and saved in a memory assigned to the laser apparatus. In one alternative, the correction list can be determined at the start of the correction iteration steps in the case of the largest representative particle diameter and then saved in the memory to be used for all subsequent correction iteration steps.

A vertical-cavity surface-emitting laser is preferably used as semiconductor laser. Such a VCSEL can be used to receive the light reflection produced by the semiconductor laser, with the light reflection generating a self-mixing interference within the semiconductor laser, which is evaluated by the evaluation device. The semiconductor laser can therefore simultaneously serve as a sensor.

In order to be able to assess the particle distribution in the particle stream in accordance with standardised criteria, the evaluation unit generates a dataset of the particle distributions according to the particulate matter standards PM1, PM2.5 and PM10. The airborne particles in PM10 are particles with a diameter less than or equal to 10 μm. PM1 (diameter <1 μm) and PM2.5 (diameter <2.5 μm) are included in PM10, but can be issued by the evaluation unit in separate data sets.

In one particular development, the laser apparatus can contain a micromechanical mirror, by means of which a flow velocity of the particle stream can be measured by the laser apparatus by the micromechanical mirror periodically deflecting the laser light. As a result, the particle diameter can be determined particularly accurately.

It is particularly preferred to use Fourier algorithms to carry out the measurements, wherein the measurement duration is specified by the block size of the Fourier algorithm. The optimum block size can be determined by a sequence of Fourier algorithms and inverse Fourier algorithms.

### BRIEF DESCRIPTION OF THE INVENTION

The invention is explained in more detail in the following using the exemplary embodiments with reference to the associated drawing. Where directions are specified in the following explanation, these are to be understood according to the reading direction of the drawing.

The drawing shows:

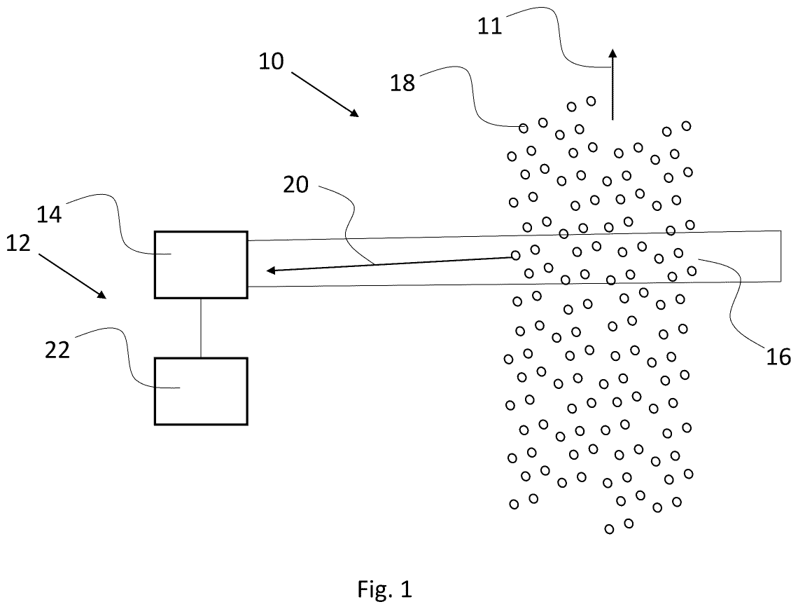

FIG. 1 a laser apparatus with a semiconductor laser for determining a particle distribution in a particle stream,

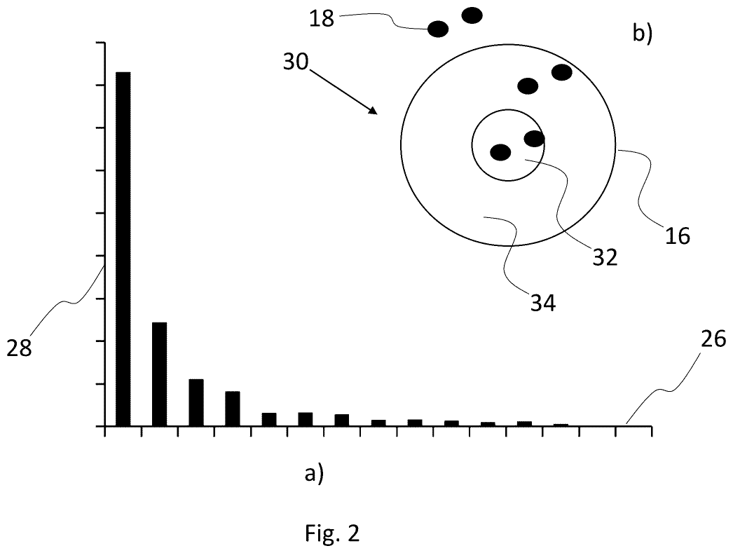

FIG. 2a a histogram of a frequency distribution of signal strength values generated by the light reflections of an illuminated particle stream,

FIG. 2b a schematic cross-section through a laser beam with an inhomogeneous light intensity profile,

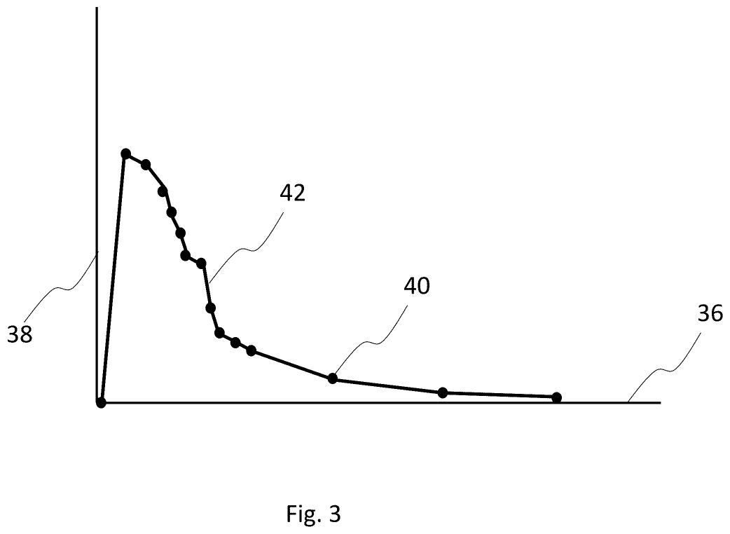

FIG. 3 a diagram of the detection sensitivity of the laser apparatus in respect of the particle diameter,

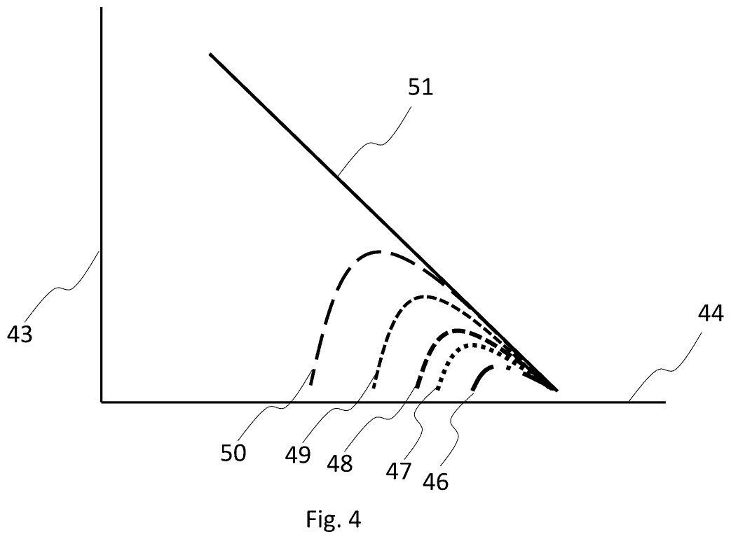

FIG. 4 a diagram showing the correlation between the signal-to-noise ratio on the Y axis and a measurement duration,

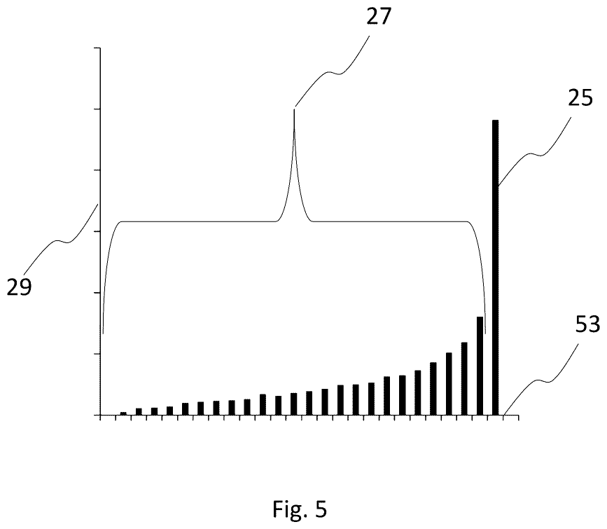

FIG. 5 a histogram of a frequency distribution of particle diameters,

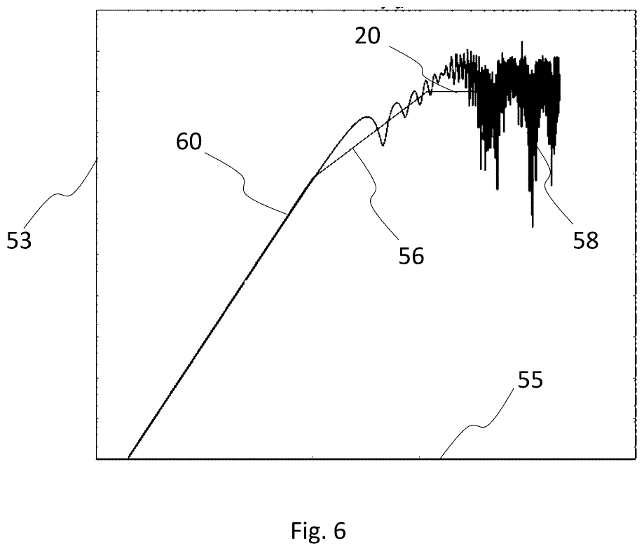

FIG. 6 a diagram the diameter-dependent backscatter of the light reflection,

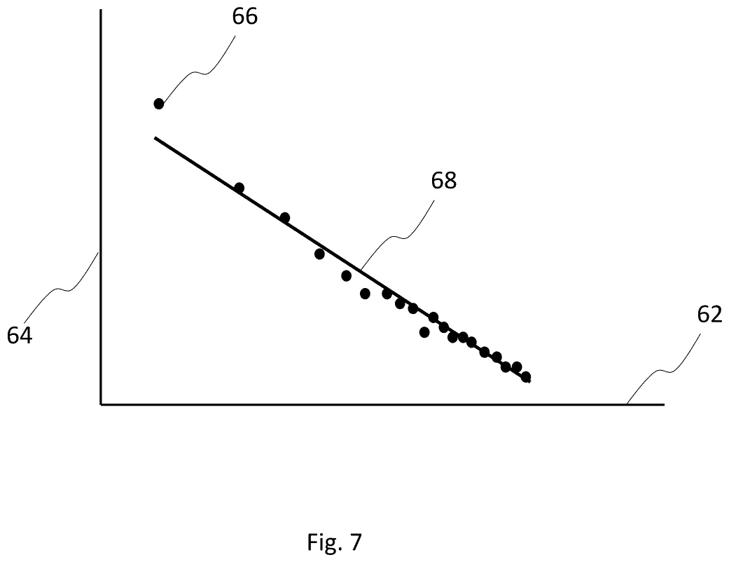

FIG. 7 a diagram of the relative error in the particle diameter estimate,

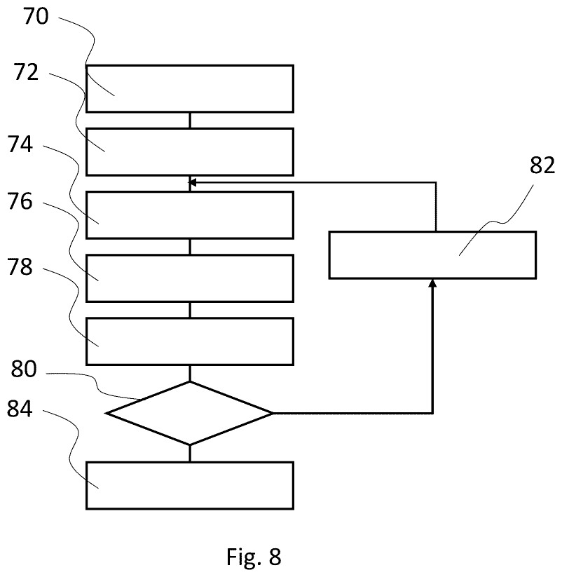

FIG. 8 a procedure for determining the particle distribution in a particle stream,

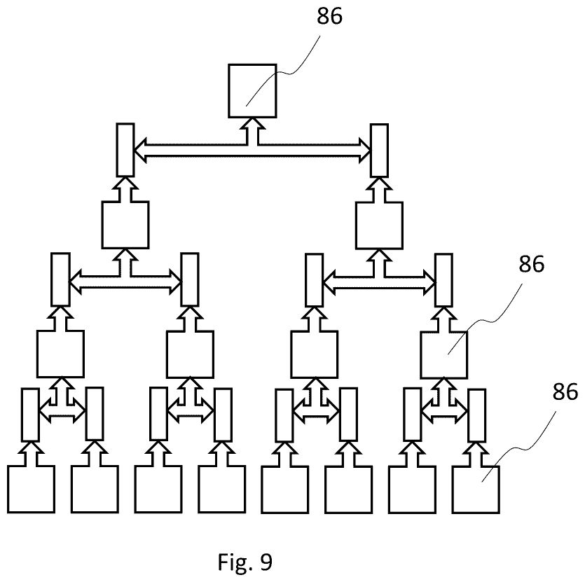

FIG. 9 an algorithm for ascertaining the optimum block size using an FFT tree, and

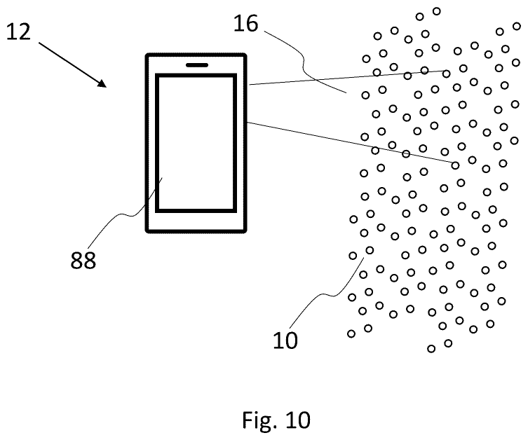

FIG. 10 a smartphone for carrying out the method according to the invention.

### EXEMPLARY EMBODIMENTS OF THE INVENTION

A method according to the invention for determining a particle distribution in a particle stream 10 with a flow velocity 11 is carried out by means of a laser apparatus 12, which is shown in FIG. 1. The laser apparatus 12 has a semiconductor laser 14 which emits a laser light 16. Preferably, the propagation axis of the laser light 16 makes an angle with the surface of the semiconductor laser, which enables advantageous detection of the particles 18 in the particle stream 10. The angle can be larger or smaller than 90°. Correspondingly, the flow velocity 11 and the propagation axis make an angle which is not 90°. The propagation axis can be an optical axis of the semiconductor laser 14 or an optical element of the laser apparatus 12. The semiconductor laser 14 is designed as what is known as a VCSEL (vertical-cavity surface-emitting laser), the laser light 16 of which is reflected at particles 18 in the particle stream 10. Preferably, the flow velocity 11 or an effective proportion of the flow velocity is aligned perpendicular to the propagation direction of the laser light 16. The light reflection 20, which is created by backscatter, penetrates back into the semiconductor laser 14, with the light reflection 20 creating a self-mixing interference within the semiconductor laser 14. FIG. 1 shows an example of the light reflection 20 of a single particle 18. In principle, every particle 18 that passes through the laser light 16 generates a light reflection 20.

The semiconductor laser 14 is connected to an evaluation unit 22 used to evaluate the self-mixing interference that was generated by the received light reflection 20. In this case, the evaluation unit 22 evaluates a reflection signal of the self-mixing interference for/with regard to a frequency distribution of the signal strength values.

Alternatively, other types of semiconductor lasers 14 can also be used which detect the light reflection 20 with the aid of a photosensor for example and provide it for evaluation.

In order to be able to determine a particle distribution according to the invention, a frequency distribution of signal strength values must be determined according to FIG. 2a), where the X axis 26 in the diagram in FIG. 2 indicates the signal-to-noise ratio and the Y axis 28 indicates the frequency of a determined signal-to-noise ratio. The frequency of the respective signal strength value is shown purely by way of example in the diagram in FIG. 2 in classes of 5 dB. Here, the frequency for a poor signal-to-noise ratio is at its highest and essentially decreases as the quality of the signal increases. In the exemplary diagram, a determination was carried out for a particle size of 0.4 micrometres for example. However, the frequency distribution of the signal strength values for particle 18 of other sizes is similar if the particle density in the particle stream 10 analysed is the same.

The signal strength and therefore the signal-to-noise ratio is influenced by an inhomogeneous intensity profile 30 of the laser light 16 extending transverse to the propagation direction of the laser light 16, as shown schematically for an exemplary laser mode in FIG. 2b). If a particle 18 passes through a region 32 of the laser light 16 that has a high light intensity, then a strong light reflection 20 and therefore a high signal-to-noise ratio is generated. Furthermore, the strength of the light reflection 20 also depends on the particle diameter, since a larger particle 18 presents a larger surface area for reflection of the laser light 16.

However, most particles 18 pass through regions 34 having a weaker light intensity which lie outside the focus the laser light 16 or at the edge region of the laser beam. Accordingly, the frequency of signal strength values with a poor signal-to-noise ratio is higher than with a good signal-to-noise ratio. In the case of a natural particle distribution having different particle diameters, a particle 18 with a first particle diameter that passes through the region 32 with high light intensity can generate a signal-to-noise ratio that has the same magnitude as that generated by a particle 18 which has a second particle diameter that is larger than the first particle diameter and which passes through the region 34 with weaker light intensity.

FIG. 3 shows a diagram of the detection sensitivity of the laser apparatus 12 with regard to the particle diameters. The X axis 36 indicates the particle diameter and the Y axis 38 indicates a detection rate of the respective particle diameter relative to a fixed measurement duration, which can be 1 minute for example. The detection rate can be expressed in μg/m³. As the particle diameter increases, the detection rate decreases with a practicable measurement duration, which suggests a reduced sensitivity of the laser apparatus. The sensitivity is also low for very small diameters, which are less than 1 micrometre for example. Here, the detection rate falls abruptly from a maximum value to an undetermined value. In the diagram in FIG. 3, the dots represent measurement points 40 which are connected to each other by an extrapolation curve 42.

A diagram in FIG. 4 shows a correlation between the signal-to-noise ratio on the Y axis 43 and a measurement duration on the X axis 44. The Y axis 43 has a logarithmic scale. The measurement duration can be the Fourier transform block size correlated with a sampling time or sampling rate.

The diagram shows a set of curves obtained from reflection signals from the self-mixing interference by Fourier transformations. Here, each curve 46, 47, 48, 49, 50, 51 in the set of curves represents a specific position of a particle 18 with a constant particle diameter where it passes through the laser beam of the laser light 16.

The curve 46 represents a particle 18 passing through a region of the laser beam that has a low light intensity and therefore low light reflection 20. It can be seen in this case that the curve 46 has the lowest maximum in the set of curves. The maximum of the curve 46 arises at an optimum measurement duration along the X axis 44, and it can be seen that the maximum of the curve 46 is formed over a longer measurement duration compared to the maxima of the other curves 48, 49, 50, 51 of the set of curves.

The curve 47 shows a position where a particle 18 passes through the laser beam, which has a higher light intensity than in the case of curve 46. Here, the maximum of the curve 47 is to the left of the maximum of the curve 46, but the maximum of the curve 47 has a higher signal strength value of the signal-to-noise ratio. As there is greater back reflection 20 here due to the higher light intensity, shorter measurement durations are needed to achieve an optimum signal-to-noise ratio.

The backscattered light reflection increases with the order of the curves 48, 49, 50. From the curves 48, 49, 50 it can be concluded that as the light intensity increases, ever shorter measurement durations are needed to achieve an optimum signal-to-noise ratio. At the same time, it can be seen that the curves 46, 47, 48, 49, 50 coverage towards the curve 51.

The curve 51 shows the passage of the particle 18 through a region of the laser beam with such a great light intensity, such as the focus, that the particle generates the greatest possible light reflection 20 regardless of the measurement duration. Curve 51 shows particles which pass through the beam at a position without a radial offset. This therefore also includes defocussed positions (with correspondingly long dwell time in the beam). The other curves are for particles with different radial offset values. Note that particles of a constant size, regardless of the measurement duration, cannot generate a higher signal-to-noise ratio. Because of the logarithmic scale of the Y axis 43, the curve 51 is depicted as a straight line in FIG. 4. Depending on particle diameter, the set of curves shifts along the abscissa, in which case the characteristics of the set of curves with regard to the position of the maxima and the convergence towards the curve 51 remain at least qualitatively the same.

Here, the straight line represents the following relationship, where SNR is the signal-to-noise ratio, d is the particle diameter, t is the measurement duration and v is the flow velocity 11:

SNR˜d²·t⁻³·v⁻⁴

The particle diameter d is lastly determined as a function of the measurement duration t and the flow velocity 11 v of the particles 18 in the particle stream 10. In this case, the particle diameter can be determined according to

d˜SNR^{0.5}·t^{1.5}·v²

The flow velocity 11 can be determined by means of GPS data, data from a weather service and/or data from a measurement with the laser apparatus 12 and/or an additional sensor apparatus (not illustrated).

As an alternative or in addition, a periodic frequency modulation can be applied to the laser light 16, so that a velocity of the particles 18 passing through the laser light 16 can be determined.

Another alternative (not illustrated) can include a laser apparatus 12 that has a micromechanical mirror, by means of which a flow velocity 11 of the particle stream 10 through the laser apparatus 12 can be ascertained. For this purpose, the laser light 16 is periodically deflected by the micromechanical mirror.

Alternatively, a laser apparatus 12 having a plurality of lasers can be used, which enables the particle velocity to be measured by means of Doppler shift. An average particle velocity is ascertained as a result.

FIG. 5 shows a histogram of a frequency distribution in which so-called bins, which represent classes of particle diameters, are plotted along the X axis 53. The frequency of a specific particle diameter can be read from the Y axis 29. Using the relationship from FIG. 4, a particle diameter d can be ascertained for each signal strength value of a measured particle 18. Optionally, the frequency distribution from FIG. 2 can be used to determine the particle diameter d. This is preferably an estimate of the particle diameter based on the above-mentioned relationship.

The largest particle diameter occurs most frequently as determined based on the relationship obtained from FIG. 4. Here a tail 27 is formed from bins with particle diameters that are smaller than the largest particle diameter 25. It transpires that the largest particle diameter actually occurs in the particle stream 10 and no larger particle diameters occur in the particle stream 10. The particle diameters can be determined by a processor unit of a computer and/or the evaluation unit 22. In the case of a particle stream in which all particles have the same particle diameters, this particle diameter is detected the most frequently.

FIG. 6 shows a diagram of the diameter-dependent backscatter of the light reflection 20, wherein the backscatter intensity is shown on the Y axis 53 and the particle diameter d on the X axis 55, where the Y axis 53 and the X axis 55 scale logarithmically. For particles 18 with a particle diameter d of greater than 1 micrometre, no correction is needed, so that a curve fit 54 corresponding to a constant is possible.

However, a diameter correction is needed for particle diameters <1 micrometre, in which case a correction of the particle diameter d according to

d′=d^{0.5}

can be determined from a curve fit 56 of the measurement curve 58, where d′ is the corrected reduced particle diameter.

A further curve fit 60 shows that, for particle diameters d<0.1 micrometre, a greater diameter correction should be carried out. In this case, the corrected particle diameter d″ is

d″=d^{0.25}

and is thus reduced in size compared to the corrected particle diameter d′.

The diameter correction is therefore only carried out for some of the particle diameters, namely for the particle diameters which are smaller than 1 micrometre.

Alternatively, the curve fits 54, 56, 60 can be described by a common function forming the basis of a continuous model of backscatter efficiency using the principles of the linear filter theory. Keeping in mind that the amplitude of a second-order high-pass filter has a slope that is proportional to the square of the frequency and that this is similar to the slope of the backscatter efficiency that is proportional to the square of the particle diameter d, the backscatter efficiency can be modelled as a cascade of two second-order high-pass filters with inflection points at 0.1 or 1 micrometre respectively:

$$E = \vert \frac{{s}_{1}^{2}}{{s}_{1}^{2} + \frac{2 {s}_{1}}{\sqrt{2}} + 1} \cdot \frac{{s}_{2}^{2}}{{s}_{2}^{2} + \frac{2 {s}_{2}}{\sqrt{2}} + 1} \vert ,$$

where s1=i·d/(2π0.1), s2=i·d/(2π1) and i=√(−1). Note that because of the cascade of the two order sections below the lowest limit value of 0.1, the backscatter efficiency is proportional to D4=D2·D2.

In FIG. 7, the relative error of the particle diameter estimate is plotted on the X axis 62 and the corresponding correction of the frequency of a particle diameter in relation to the relative error is plotted on the Y axis 64. Here, the correction of the frequency of a particle diameter is always between 0 and 100%, so that the frequency distribution of the particle diameters in the particle stream 10 from FIG. 5 not have a negative value after the frequency correction.

Here, a curve fit 68 which corresponds to a straight line can be determined for the ascertained correction values 66, where the X axis 62 is logarithmically scaled. Lastly, it can be established that, regardless of the particle diameter, the curve fit 68 of the relative error is approximately identical and the frequency distribution of the tail 27 can be corrected accordingly. Consequently, it can be assumed that each particle diameter of the tail 27 from FIG. 5 can be corrected by means of the same frequency correction. The respective frequency of the particle diameter in the tail 27 is reduced in the process.

FIG. 8 shows a procedure for determining the particle distribution in a particle stream, which can be executed as a computer program on a computer unit. Furthermore, the computer program can be stored on storage media.

The procedure includes in a first step 70 determining the particle diameters d according to

d˜SNR^{0.5}·t^{1.5}·v²

from the frequency distribution from FIG. 2 and the correlation from FIG. 4.

In a further step 72, the histogram from FIG. 5 is created, where bins with classes of particle diameters are created, for example in 0.1 micrometre intervals. The histogram from FIG. 5 represents a diameter list.

In the next step 74, the bin with the largest particle diameter 25 is selected from the diameter list as a representative particle diameter. The tail 27 from particle diameters that are smaller than the representative particle diameter is used to create a correction list.

In a further step 76, the contribution to a particle distribution, e.g. according to PM1, PM2.5 and/or PM10, is calculated for the representative particle diameter. The detection sensitivity of the laser apparatus 12 according to FIG. 3 is taken into consideration in this case. At the same time, the diameter correction is carried out so that the corrected particle diameters d′ and/or d″ are obtained depending on the particle diameter d.

The ascertained particle diameters d, d′, d″ are stored in a corrected diameter list in a step 78.

In a next step 80, a new representative particle diameter that is smaller than the previous representative particle diameter is selected until the smallest particle diameter in the diameter list has been processed. Preferably, the next smaller particle diameter is selected as a new representative particle diameter.

If the smallest particle diameter in the diameter list has not yet been reached, a typical particle distribution is subtracted from the remaining frequency distribution from a correction list, which is created from the tail 27 and the relative error according to FIG. 7, and at the same time the largest or the representative particle diameter is increased by the same amount. As a result, an approximately realistic value for the frequency of the representative particle diameter is obtained. This generates a frequency correction of the diameter list.

If the frequency correction iterations have been carried out to the extent that the smallest particle diameter in the diameter list is reached and all particle diameters corrected by means of the diameter correction and the frequency correction are stored in the corrected diameter list, preferably stored on a storage medium, the particle distribution can be output in a step 84. An output of the PM1, PM2.5 and/or PM10 can be output.

The steps shown in FIG. 8 can also be effected in a different order. For example, the diameter correction can be effected at the end of the procedure. Furthermore, a correction list can be created at the start of the procedure.

Alternatively, an approach can be also used to derive the statistically most probable distribution of the particle sizes from all signal-to-noise ratios and measurement durations.

FIG. 9 shows an algorithm for ascertaining the optimum block size by means of an FFT tree. For this purpose, Fourier analyses 86 are performed in a plurality of parallel steps on various levels of a binary tree. The measurement duration can be determined and the optimum signal-to-noise ratio is ascertained.

As shown in FIG. 10, the laser apparatus 12 can be used to carry out the procedure from FIG. 8 in a smartphone 88. The user of the smartphone 88 can thereby measure a localised particle distribution in the ambient air.

The data ascertained therefrom can be displayed to the user directly on the smartphone 88. In addition, the data can be transmitted over the internet to environment-related services. Furthermore, the particle distribution can be determined by means of the smartphone 88 or measurement data can be transmitted by the smartphone 88 to a cloud-based service that performs the method according to the invention.

The method according to the invention can also be carried out on stationary installations in road traffic, on or in buildings and anywhere where a particle distribution is to be ascertained.

1. A method for determining a particle distribution in a particle stream (10) using a laser apparatus (12) which has at least one semiconductor laser (14) that emits a laser light (16) having an inhomogeneous intensity profile (30), the method comprising:
receiving a light reflection (20) of the laser light (16) generated at particles (18) of the particle stream (10),
an evaluation unit (22) connected to the laser apparatus (12) evaluating a reflection signal generated by the light reflection (20) in respect of a frequency distribution of signal strength values which is generated on the basis of the intensity profile (30) when the particles (18) penetrate the laser light (16),
a processor unit determining the particle diameters of the individual particles (18) on the basis of the signal strength values,
carrying out a diameter correction of at least some of the determined particle diameters on the basis of the sensitivity of the laser apparatus (12),
creating a diameter list of the frequency distribution of the particle diameters,
carrying out a frequency correction of the diameter list using a correction list,
storing the corrected diameter list on a storage medium.

2. The method according to claim 1, wherein the particle diameter is determined on the basis of a measurement duration and a flow velocity (11) of the particles (18).

3. The method according to claim 1, wherein the diameter correction is effected for particle diameters <1 micrometre.

4. The method according to claim 1, wherein the correction list is created by storing the frequency distribution of the particle diameters that are smaller than a representative particle diameter from the diameter list.

5. The method according to claim 4, wherein the frequency of particle diameters that are smaller than the representative diameter is reduced by the correction list.

6. The method according to claim 5, wherein the frequency of the representative diameter is increased by the correction list.

7. The method according to claims 6, wherein the number of different diameters in the diameter list specifies the repetitions of the frequency corrections to the diameter list, wherein the largest particle diameter is selected as the representative diameter in the first frequency correction, and the smallest particle diameter in the diameter list is selected as the representative diameter in the last frequency correction.

8. The method according to claim 7, wherein the correction list is determined only once for a representative diameter which corresponds to the largest diameter in the diameter list, wherein this correction list is used for all frequency corrections.

9. The method according to claim 1, wherein the semiconductor laser (14) is a vertical-cavity surface-emitting laser.

10. The method according to claim 1, wherein the light reflection (20) is received by the semiconductor laser (14), wherein the light reflection (20) generates a self-mixing interference within the semiconductor laser (14), which is evaluated by the evaluation device (22).

11. The method according to claim 1, wherein a periodic frequency modulation is applied to the laser light (16).

12. The method according to claim 1, wherein a data set of the PM1, PM2.5 and PM10 particle distributions in the particle stream (10) is generated by the evaluation unit (22).

13. The method according to claim 1, wherein a flow velocity (11) of the particle stream (10) is measured by means of a micromechanical mirror assigned to the laser apparatus (12) by the micromechanical mirror periodically deflecting the laser light (16).

14. The method according to claim 1, wherein a measurement duration is specified by the block size of a Fourier algorithm.

15. The method according to claim 14, wherein the optimum block size is determined by a sequence of Fourier algorithms and inverse Fourier algorithms.

16. A computer program product having a computer program, comprising instructions for carrying out the method according to claims 1.

17. A laser apparatus (12) for carrying out the method according to claim 1.
